(19) United States
(12) Patent Application Publication
(10) Pub. No.: US 2005/0241739 A1
(43) Pub. Date: Nov. 3, 2005

(54) Removable tire chain assembly with paddles

(76) Inventor: Steve Kott, Irvine, CA (US)

Correspondence Address: STETINA BRUNDA GARRED & BRUCKER, 75 ENTERPRISE, SUITE 250, ALISO VIEJO, CA, 92656, US

(21) Appl. No.: 10/834,507

(22) Filed: Apr. 29, 2004

(51) Int. Cl. B60C 11/03

(52) U.S. Cl. 152/223

(57) ABSTRACT

A removable tire chain assembly with paddles is provided for motorcycles, bicycles, ATVs, and off-road recreational vehicles, for enhancing traction in sand, loose dirt and muddy terrain. The removable tire chain assembly comprises a chain lattice, having opposing connecting ends, adapted to be circumferentially and radially wrapped around and secured about a tire and rim; and a plurality of paddle assemblies attached to said chain lattice such that said plurality of paddle assemblies are positioned on a tread portion of the tire.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

1. Field of the Invention

The present invention relates to tire traction devices that may be temporarily attached to a tire and wheel by a chain assembly and then removed when the traction device is no longer required. In particular, the present invention relates to tire chain assemblies having plurality of paddles for delivering superb traction in sand, loose dirt and/or muddy terrain.

2. Background of the Invention

Off-road recreation has long been a favorite pastime for enthusiasts of motorcycles, ATVs, dune buggies, mountain bikes and other recreational vehicles. There are many different forms of off-road sports which have developed over the years, including trail riding, motocross, dirt track racing, off-road rallies, enduros, trials, hill climbing, dune riding, mud bogging, and baja racing to name just a few.

The type of terrain of which the off-road activities are carried out in is usually a major consideration in the selection of tires for the vehicle. For instance, a motorcycle or ATV utilized in motocross usually has “knobbies” for the tread pattern. And in such an instance, the knobbies are adapted for the terrain conditions experienced on a motocross track (typically loose and packed dirt). Or perhaps, a vehicle which is used for both street and trail riding, may utilize a tire with a more conservative tread pattern optimized for both street and trail conditions. There are even motorcycles which have embedded metal spikes in the tires for circle track racing on snow and ice.

One area of particular interest in off-road recreation is having the ability to proficiently traverse sand, loose dirt and or extremely muddy terrain. Most tires installed on off-road vehicles are optimized for a variety of conditions including hard packed dirt, loose rocky terrain, pavement and asphalt, mud, grass and forest-like terrains. Although, these tires overall work well for a variety of terrains, by design, they tend not to be optimized for only sand, loose dirt and/or extremely muddy terrains.

In the past and currently when off-roaders desire to focus their riding in sandy or very muddy terrains, a specialized tire with pronounced paddles, cups or scoops is the preferred tread design and/or pattern. Such paddle tires can be obtained through special racing tire suppliers. Some paddle tires are even hand carved to meet specific custom tread patterns not available aftermarket. Other times, the tread pattern of a conventional tire is shaved off, and paddles are glued onto the tire.

Typically, to be prepared for sandy or excessively muddy conditions, the owner of the vehicle will outfit it with the specialized tires with paddles either (1) before arriving at the off-road venue, or (2) while at the riding venue. This preparation typically entails having an extra rim or set of rims which have the cupped tire already mounted thereto. Additionally, the tires and rims have to be changed over. Needless to say, the preparation for changing over the conventional tires to specialized cupped tires can be very time consuming. Moreover, the cost of having a spare set of cupped tires installed on an extra set of rims on hand for only sandy or muddy conditions can be prohibitively expensive for many off-road enthusiasts.

A disadvantage of using the paddle tires is that once the vehicle is configured with the paddle tires, the vehicle is only useful in the terrain of which the tires are designed for, which is, sand, very loose dirt and/or extremely muddy conditions. Otherwise, while the paddle tires are installed on the vehicle, the vehicle cannot be used on more commonly traveled terrains, such as pavement, dirt roads, packed dirt, trails, etc. Thus, with paddle tires installed, the vehicle becomes somewhat one-dimensional and limited with respect to the types of terrains it can traverse.

Also some vehicles are configured for dual-purpose on-road and off-road terrains. For instance, some motorcycles are street legal, but are also designed to be ridden off-road. In this circumstance, the operator may want to drive the motorcycle on the road to get to the riding venue. Furthermore, many times, the specialized cupped tire is only needed for a short period. Thus, many times the off-roader faces a choice of having to determine exactly what type of terrain is desired to be ridden, select the proper tires, install them on the vehicle, and then leave them on the vehicle for the duration of the riding activity.

It would be desirable to provide an inexpensive removable off-road vehicle tire chain assembly which has paddles. In particular, it would be desirable to provide a chain assembly with paddles which could be installed over conventional off-road tires, similar to that of snow tire chains. Such an invention would allow off-road enthusiasts to more easily convert their vehicle's tires into sand, loose dirt or mud gripping tires. Moreover, the expense of having to own a second set of specialized tires and rims can be eliminated. Furthermore, installation time and removal time can be significantly reduced since the chain assemblies with paddles could be installed in the field and used only when needed. Overall, such a proposed chain assembly with paddles would provide much more operative flexibility than then previously known and used methods.

### BRIEF SUMMARY OF THE INVENTION

The aforementioned disadvantages are overcome by the present invention which provides numerous exemplary embodiments of a removable motorcycle tire chain assembly with paddles which may be installed on a tire and rim of a vehicle, and in more particular, a vehicle intended to be operated off-road in sand, loose dirt and/or muddy terrains. The present invention operates and has a similar construction to that of conventional snow chains, however, the present invention also includes paddle assemblies.

The present invention is an inexpensive removable vehicle tire chain assembly having paddles as an alternative to specialized paddle tires. The present invention provides a chain assembly with paddles which can be easily installed over conventional tires and off-road tires, similar to that of snow tire chains. As a result, the present invention allows off-road enthusiasts the ability to more easily convert their vehicle's tires from conventional treaded tires, to more aggressive tires developed especially for sand, loose dirt or muddy terrain conditions. Moreover, the expense of having to own a second set of specialized tires and rims is eliminated. Furthermore, installation time and removal time can be significantly reduced since the chain assemblies with paddles may be installed in the field and used only when needed. Overall, the present invention provides much more operative flexibility than then previously known and used methods.

According to an aspect of the present invention, a removable tire chain assembly with paddles is provided for motorcycles, ATVs, bicycles/mountain bikes and other off-road recreational vehicles, for enhancing traction in sand, loose dirt and muddy terrain. The removable tire chain assembly comprises a chain lattice, having opposing connecting ends, adapted to be circumferentially and radially wrapped around and secured about a tire and rim; and a plurality of paddle assemblies attached to the chain lattice such that the plurality of paddle assemblies are positioned on a tread portion of the tire.

According to another aspect of the present invention, a first chain lattice is provided which comprises a pair of inner circumferential chains arranged in a parallel manner; a plurality of radially oriented chains transversely intersecting and interconnected to the pair of inner circumferential chains; and a pair of outer circumferential chains comprising, a leftside chain laterally positioned away from and generally parallel to the pair of inner circumferential chains; a rightside chain laterally positioned away from and generally parallel to the pair of inner circumferential chains; wherein the plurality of radial oriented chains are transversely interconnected to and terminated at the pair of outer circumferential chains.

According to another aspect of the present invention, a second embodiment of a chain lattice is provided comprising a pair of outer circumferential chains comprising a leftside chain laterally positioned away from and generally parallel to a rightside chain; a plurality of forward radially oriented chains interconnecting the pair of outer circumferential chains, the plurality of forward radially oriented chains attached to the pair of outer circumferential chains in a declined orientation, each of the forward radially oriented chains having a leftside and rightside connecting portion; a plurality of rearward radially oriented chains generally transversely positioned between the pair of outer circumferential chains, each rearward radially oriented chain having a left end attached to a leftside connecting portion and a right end attached to a rightside connecting portion of a respective one of the plurality of forward oriented chains.

According to still further aspects of the present invention, each of the plurality of paddle assemblies comprises a paddle base; and a paddle integrally formed to the paddle base. In another aspect of the present invention, the paddle base includes a generally planar member having one of a rectangular and oval footprint. The paddle base may have a preformed arc which conforms to the circular arc and rounded sides of the tire. Also, the paddle base may be formed of a pliable material which when installed on the outer surface of the tire, the paddle base bends and conforms to the circular arc of the tire and the rounded sides of a tire.

According to other aspects of the present invention, the paddle has a concave side adapted to engage terrain and a backing portion formed behind the concave side. In another aspect of the present invention, the concave side of the paddle is oriented transverse to the rotational direction of the tire. In another aspect of the present invention, the concave side of paddle may be oriented at an inclined angle with respect to the rotational direction of the tired. Moreover, the paddle may have a generally triangular cross section defined by the concave side and the backing portion.

According to other aspects of the present invention, the paddle base has a pair of receiving conduits formed internally for receiving portions of the chain lattice. In another aspect of the present invention, the paddle base further includes retaining sleeves disposed within the receiving conduits for receiving portions of the chain lattice. In yet still another aspect of the present invention, the receiving conduits are oriented transverse to the rotational direction of the tire, or may be oriented parallel to the rotational direction of the tire.

Furthermore, still other aspects of the present invention include the paddle base being attached to portions of the chain lattice by fastening hardware. For instance, the fastening hardware may comprise at least one of J-bolts, U-bolts or rivets. Additionally, the fastening hardware further may include a backing plate, washer and fastening nut. In other aspects of the present invention, the fastening hardware comprises a threaded stud with an anchor protruding from the stud, wherein a portion of the stud is embedded within the paddle base and a threaded portion is exposed for receiving at least one of a backing plate, washer and fastening nut.

And, in another aspect of the present invention, the paddle base is molded with portions of the chain lattice positioned within and embedded within the paddle base for attaching the paddle base to the chain lattice.

Other exemplary embodiments and advantages of the present invention may be ascertained by reviewing the present disclosure and the accompanying drawings.

### BRIEF DESCRIPTION OF THE DRAWINGS

The present invention is further described in the detailed description that follows, by reference to the noted drawings by way of non-limiting examples of preferred embodiments of the present invention, in which like reference numerals represent similar parts throughout several views of the drawings, and in which:

FIG. 1 illustrates a first exemplary embodiment of a removable tire chain assembly with paddles installed on a tire and rim, according to an aspect of the present invention;

FIG. 2 is a front view of the first exemplary embodiment of the removable tire chain assembly with paddles installed on the tire and rim, according to an aspect of the present invention;

FIG. 3 illustrates a second exemplary embodiment of a removable tire chain assembly with paddles installed on a tire and rim, according to an aspect of the present invention;

FIG. 4 is a front view of the second exemplary embodiment of the removable tire chain assembly with paddles installed on a tire and rim, according to an aspect of the present invention;

FIG. 5 is a top view of one exemplary embodiment of a paddle assembly which utilizes a pair of retaining conduits to retain the chain lattice, according to an aspect of the present invention;

FIG. 6 is a side view of the exemplary embodiment of the paddle assembly from FIG. 5, according to an aspect of the present invention;

FIG. 7 is a cross sectional view of the exemplary embodiment of the paddle assembly taken about Section 7-7 of FIG. 6, according to an aspect of the present invention;

FIG. 8 is a top view of another exemplary embodiment of a paddle assembly which utilizes a pair of transversely oriented retaining conduits to retain the chain lattice, according to an aspect of the present invention;

FIG. 9 is a side view of the exemplary embodiment of the paddle assembly from FIG. 8, according to an aspect of the present invention;

FIG. 10 is a cross section view of the exemplary embodiment of the paddle assembly taken about Section 10-10 of FIG. 10, according to an aspect of the present invention;

FIG. 11 is a top view of an alternative paddle base shape, according to an aspect of the present invention;

FIGS. 12A-D are a side views of an exemplary embodiment of a paddle assembly which utilizes various fastening methods and orientations to retain the chain lattice, according to an aspect of the present invention;

FIG. 13 is a top view of an alternative embodiment of the paddle assembly which arranges the chain lattice underneath the paddle assembly and of which utilizes a backing according to an aspect of the present invention;

FIGS. 14A-B are side views of an exemplary embodiment of a paddle assembly which arranges the chain lattice transversely across the top paddle assembly of which may also use a recess to positioned the chain lattice within for a reduced profile (see FIG. 14B);

FIG. 15 is a top view of FIG. 14B which shows the transverse recesses, according to an aspect of the present invention;

FIG. 16 is a top view of another embodiment of a paddle assembly in which portions of the chain lattice are longitudinally embedded within the paddle base, according to an aspect of the present invention;

FIG. 17 is a top view of another embodiment of the paddle assembly in which portions of the chain lattice are transversely embedded within the paddle base, according to an aspect of the present invention;

FIG. 18 is a top view of another embodiment of the paddle assembly which utilizes an elongated paddle transversely oriented across the paddle base, according to an aspect of the present invention;

FIG. 19 is a top view of a ninth embodiment of the paddle assembly which utilizes an elongated paddle oriented in an angularly inclined position the paddle base, according to an aspect of the present invention;

FIG. 20 is a side view of another embodiment of the paddle assembly which utilizes recesses for the mounting hardware, according to an aspect of the present invention;

FIG. 21 is a side view of another embodiment of the paddle assembly which utilizes u-bolts for the mounting hardware, according to an aspect of the present invention;

FIG. 22 illustrates a third exemplary embodiment of a chain lattice, according to an aspect of the present invention; and

FIG. 23 illustrates a fourth exemplary embodiment of a chain lattice, according to an aspect of the present invention.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

Overview of the Present Invention

The present invention provides numerous exemplary embodiments of a removable tire chain assembly with paddles which may be installed on a tire and rim of a vehicle or bicycle, and in more particular, a vehicle intended to be operated off-road in sand, loose dirt and/or muddy terrains. The present invention operates and has a similar construction to that of conventional snow chains, however, the present invention also includes paddle assemblies. Thus, the present invention may be installed directly over conventional tires and rims of a vehicle. Moreover, the present invention allows off-road enthusiasts to more easily convert their vehicle's tires from conventional treaded tires, to highly aggressive tires developed especially for sand, loose dirt and/or muddy terrain conditions, resulting in much more operative flexibility than then previously known and used methods.

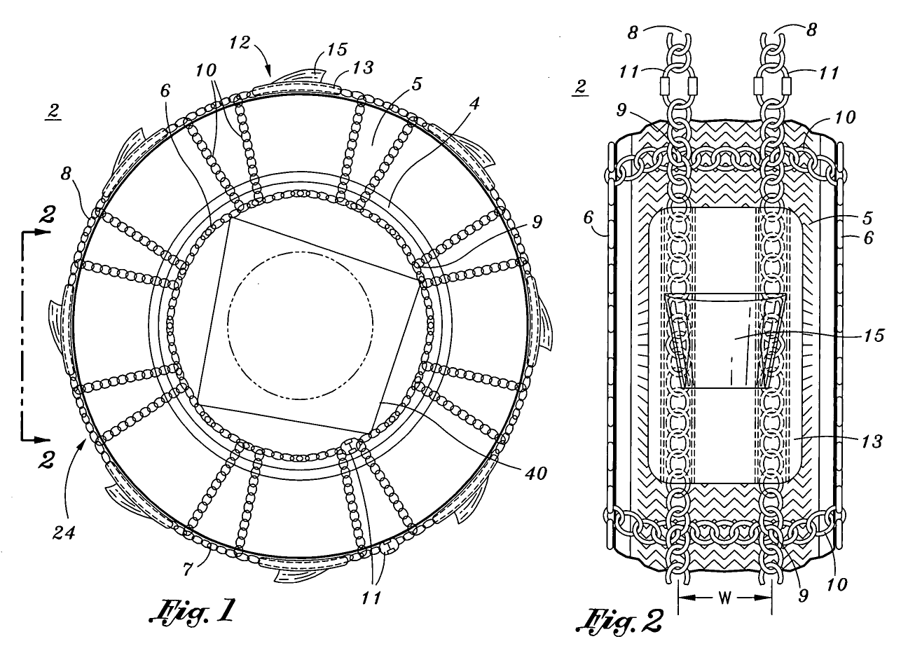

The Detailed Description initially discloses a first and second embodiment of the present invention 2, 3 as illustrated in FIGS. 1 through 4. Also variant of chain lattices are described in FIGS. 22 and 23. Next, several different embodiments or variants of paddle assemblies 12 and various techniques to connect the chain lattices 24 and 26 to the paddle assemblies 12 are provided, as illustrated in FIGS. 5 through 21. It is noted that the numerous embodiments of the present invention may be best described according to it main components, including a chain lattice 24 (for first embodiment 2) or 26 (for second embodiment 3), a plurality of paddle assemblies 12, and the manner in which the chain lattice 24 or 26 are attached to the paddle assemblies 12. The numerous embodiments and variants of the removable tire chain assembly 2, 3 with paddles are now herein described below in greater detail.

First Exemplary Embodiment of Removable Tire Chain Assembly with Paddles

FIGS. 1 and 2 illustrate a first exemplary embodiment of a removable tire chain assembly 2 with paddles installed on a motorcycle tire 5 and rim 4. In particular, FIGS. 1 and 2 depict a first embodiment of the chain lattice 24 which is adapted to be secured around the tire 5 and rim 4.

The first exemplary chain lattice 24 may use a variety of chains or cables 7 well known in the art for manufacturing tire chain assemblies. The chains or cables 7 are preferably made from high-strength metal. In general, to form the chain lattice 24, portions of chain or cables 7 are interconnected, linked, or tied together in any manner known in the art to form a chain joint 9.

With regard to the first embodiment of the chain lattice 24, a pair of outer circumferential chains 6 (left and right) form the exterior sides of the chain assembly 2. Each outer chain 6 has opposing ends which may be terminated with a chain release or chain connector 11 such that the opposing ends may be connected together. The length of each outer circumferential chain 6 should equate to a circumference length that is less than the actual circumference of the tire 5 of which the chain assembly 2 is to be installed. Thus, as shown in FIG. 1, when installed around the tire 5 and wheel 4, the outer chains 6 will be able to be drawn together to form a tightened circular chain ring positioned concentrically about each side of the tire 5 and wheel 4.

A pair of inner circumferential chains 8 (left and right) form the inner region of the chain lattice 24 which covers the tread of the tire 5. Each inner chain 8 has opposing ends which may also be terminated with a chain release or chain connector 11 such that the opposing ends may be connected together. The length of each inner circumferential chain 8 should approximately equate to a circumference length equal to the actual circumference of the tire 5 on which the chain assembly 2 is to be installed. Thus, as shown in FIGS. 1 and 2, when installed around the tire 5 and wheel 4, the inner chains 8 are adapted to be able to be drawn together to form a tightened circular chain ring positioned around the tread region of a the tire 5. Moreover, the pair of inner circumferential chains 8 are oriented in a parallel manner with respect to each other being spaced apart by a selected width W (see FIG. 2) which may vary according to tire width size and paddle assembly 12 configuration.

A plurality of radially oriented chains 10 transversely intersect the pair of inner circumferential chains 8 and terminate at the pair of outer circumferential chains 6 in a generally normal orientation. At each occurrence of an intersection between a radially oriented chain 10 and one of the circumferential chains 6 or 8, the chains 7 are linked to each other to form chain joints 9. It is noted that in the first embodiment of the chain lattice 24, a pair of radially oriented chains 10 are utilized between each paddle assembly 12 to help retain the inner circumferential chains 8 close to the tire tread area. Thus, as shown in FIGS. 1, 2 and 5, the circumferential length L of the paddle base 13, may dictate a general spacing pattern with respect to all of the radially oriented chains 10 positioned along both the outer and inner circumferential chains 6, 8.

The removable tire chain assembly 2 and chain lattice 24 is adapted to utilize a plurality of paddle assemblies 12 having various different embodiments. The various embodiments of the paddle assemblies 12, and methods of attachment to the chain lattice 24 which are illustrated in detail in FIGS. 5-7, 12A-C, 13, 16, and 18-19, will be further described later in the specification.

Second Exemplary Embodiment of Removable Tire Chain Assembly with Paddles

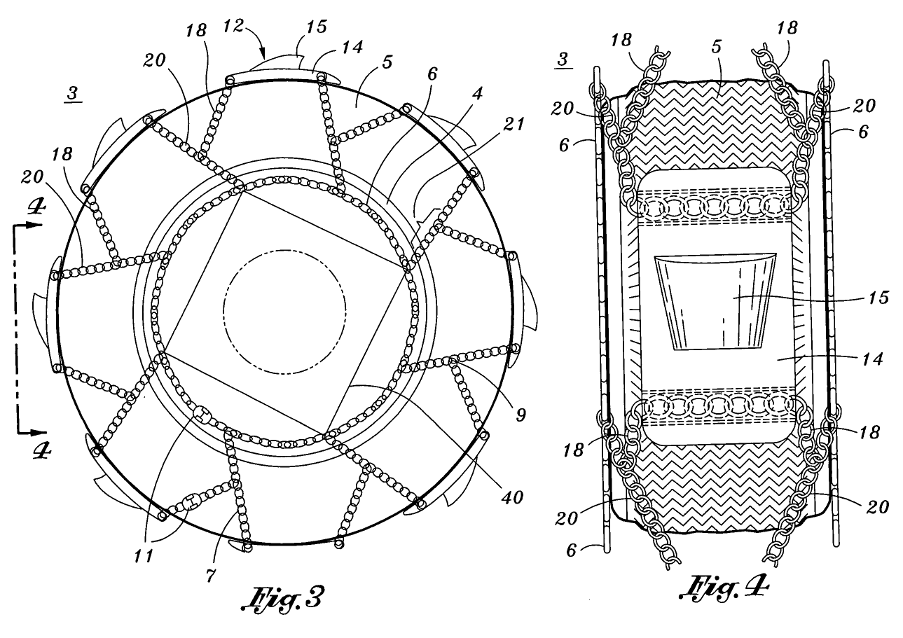

FIGS. 3 and 4 illustrate a second exemplary embodiment of a removable tire chain assembly 3 with paddles installed on the motorcycle tire 5 and rim 4. In particular, FIGS. 3 and 4 depict a second embodiment of the chain lattice 26 which is adapted to be secured around the tire 5 and rim 4.

Similar to the first exemplary chain lattice 24, the second exemplary chain lattice 26 may use a variety of chains or cables 7 well known in the art for manufacturing tire chain assemblies. The chains or cables 7 are preferably made from high-strength metal. In general, to form the chain lattice 26, portions of chain or cables 7 are interconnected, linked, or tied together in any manner known in the art to form a chain joint 9.

Also, similar to the first exemplary chain lattice 24, a pair of outer circumferential chains 6 (left and right) form the exterior sides of the chain lattice 26 of chain assembly 3. Each outer chain 6 has opposing ends which may be terminated with a chain release or chain connector 11 such that the opposing ends may be connected together. The length of each outer circumferential chain 6 should equate to a circumference length that is less than the actual circumference of the tire 5 on which the chain assembly 3 is to be installed. Thus, as shown in FIG. 3, when installed around the tire 5 and wheel 4, the outer chains 6 will be able to be drawn together to form a tightened circular chain ring positioned concentrically about each side of the tire 5 and wheel 4.

However, the second embodiment of the chain lattice 26 foregoes use of the pair of inner circumferential chains 8, as are utilized in the first embodiment of the chain lattice 24. Instead, a plurality of declined or inclined radially oriented chains 18, 20 form a lattice portion between the left and right outer circumferential chains 6. In particular, a plurality of declined forward radial chains 20 are generally transversely positioned between, attached to, and terminated at outer circumferential chains 6 such that a center portion of the each forward radial chain 20 may be attached to a forward connecting portion of the paddle assembly 12. This connection aspect will be further discussed later in the specification. Additionally, a plurality of inclined rearward radial chains 18 are also generally transversely positioned between the outer chains 6, however, the plurality of rearward chains 18 are not connected to the outer circumferential chains 6. Instead, it is noted that the plurality of inclined rearward radial chains 18 are terminated at and connected to the respective ones of the declined forward radial chains 20. Thus, a center portion of each rearward radial chain 18 may be attached to a rearward connecting portion of the paddle assembly 12.

It is further observed from FIG. 3 that the plurality of forward radial chains 20 are attached to the pair of outer circumferential chains 6 at generally equally spaced intervals. Thus, for example, if eight paddle assemblies 12 are utilized, eight declined forward radial chains 20 are utilized, and the forward radial chains 20 are spaced about the outer circumferential chains 6 at about 45 degree intervals. It is further appreciated that more or less declined forward radial chains may be used in lattice 26 depending on the size of the tire 5 and the specific application.

It is noted that each of the pair of outer circumferential chains 6 have terminating ends at which chain releases 11 or chain couplers are installed such that the chain assembly 3 may be completely wrapped around the motorcycle tire 5 and rim 4 and connected together as shown in FIGS. 3 and 4. Additionally, the declined forward radial chains 20 or inclined rearward radial chains 18 have a pair of chain releases 11 or chain couplers installed such that the chain assembly 3 may be completely wrapped around the motorcycle tire 5 and rim 4 and connected together as shown in FIGS. 3 and 4.

One aspect of the aforementioned design of chain lattice 26 is that it minimizes the amount of chain or cable 7 that is positioned directly atop the tire tread, thereby minimizing the amount of chains or cables 7 which are positioned on the tread surface of the conventional tire 5. Another benefit of the second embodiment of the chain lattice 26 is that the declined orientation of the forward radial chains 20 and the inclined orientation of the rearward radial chains 18 provides an excellent design for retaining the paddle assemblies 12 close to the tread surface of the tire 5, while at the same time reducing the total length of chain or cable 7 utilized in the lattice 26, thus reducing the weight of the lattice 26. As a result, the total rotational weight of the tire 5, wheel 4, and chain assembly 3 is reduced.

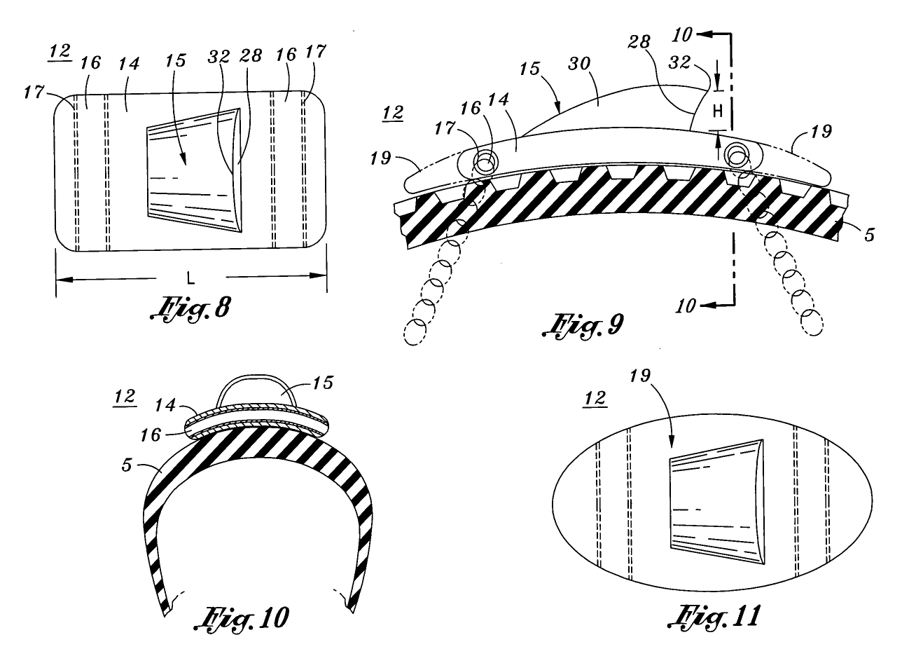

The removable tire chain assembly 3 including chain lattice 26 is adapted to utilize a plurality of paddle assemblies 12 which may have various different embodiments. The various embodiments of the paddle assemblies 12 and methods are illustrated in detail in FIGS. 8-11, 12D, 14A-B, and 15-21 and are described in a following section.

Alternative Chain Lattice Embodiments

It is recognized that the chain lattice of the present invention may be configured in a variety of manners. For example, FIG. 22 illustrates a third exemplary embodiment of a chain lattice 23, according to an aspect of the present invention. In particular, the chain lattice 23 utilizes a radial chain 10 which is interconnected between the pair of outer circumferential chains 6 to secure the rear portion of the paddle assembly 12. A declined forward radial chain 20 is interconnected between the pair of outer circumferential chains 6 to secure the forward portion of the paddle assembly 12. It is further noted that both the radial chains 10 and declined forward radial chains 20 are connected a common chain joint 9 at to the pair of outer circumferential chains 6.

FIG. 23 illustrates a fourth exemplary embodiment of a chain lattice 25, according to an aspect of the present invention. In particular, the chain lattice 25 utilizes an inclined rearward radial chain 18 interconnected between the pair of outer circumferential chains 6 to secure the rear portion of the paddle assembly 12. A declined forward radial chain 20 is interconnected between the pair of outer circumferential chains 6 to secure the forward portion of the paddle assembly 12. It is further noted that both the inclined rearward radial chains 18 and declined forward radial chains 20 are connected a common chain joint 9 at to the pair of outer circumferential chains 6.

It is further noted that chain lattices 23 and 25 are adapted to utilize the plurality of paddle assemblies 12 having various different embodiments. The various embodiments of the paddle assemblies 12 and methods that may be used in conjunction with alternative lattices 23 and 25 are illustrated in detail in FIGS. 8-11, 12D, 14A-B, and 15-21 and are next described in the following section.

Various Exemplary Embodiments of the Paddle Assemblies

The removable tire chain assembly 2, 3 (and alternative lattices 23, 25) utilize a plurality of paddle assemblies 12 of various embodiments which are illustrated in detail in FIGS. 5 through 21. Furthermore, each paddle assembly 12 may implement various chain mounting techniques, a variety of examples which are now herein discussed.

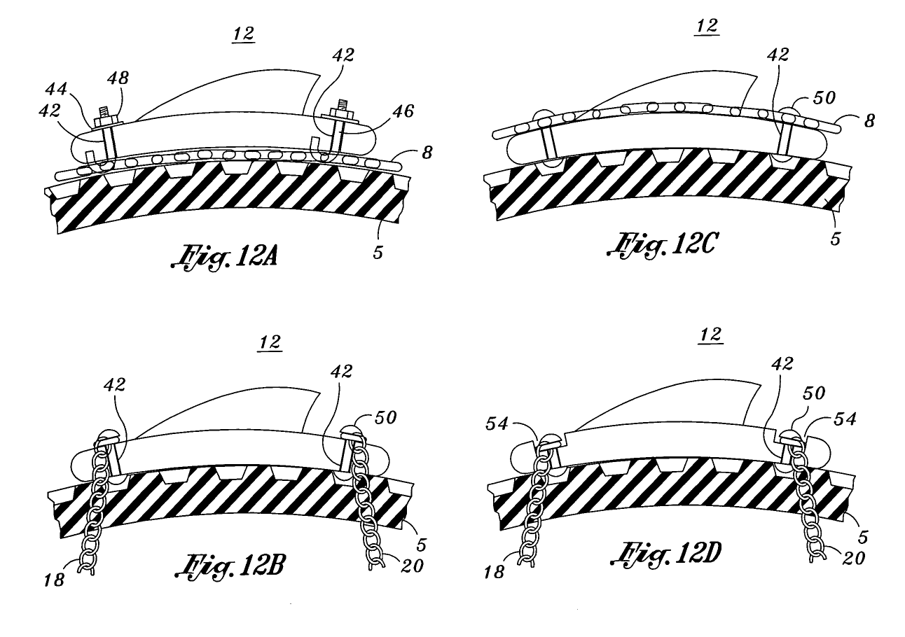

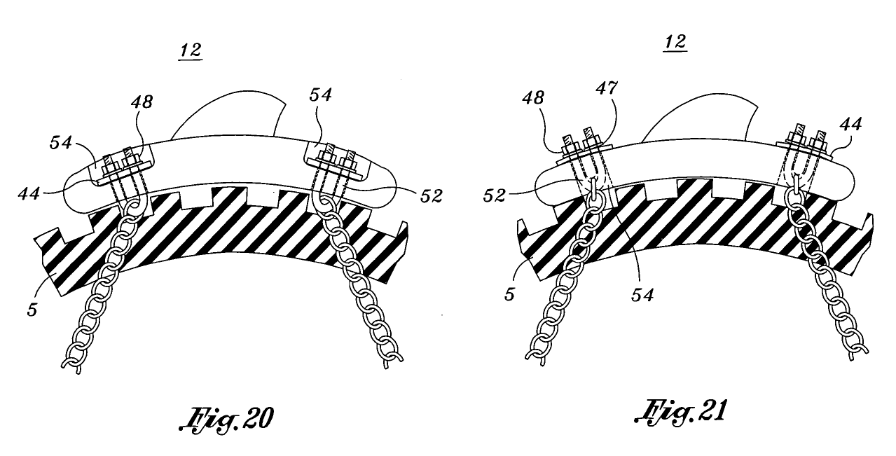

Each paddle assembly 12 has a paddle base 13 (for longitudinally oriented chains) or 14 (for transversely oriented chains) and an integrally formed paddle or cup 15, 34 (see FIG. 18) or 36 (see FIG. 19). Preferably both the paddle base 13 or 14 and paddle cups 15 34, 36 are integrally formed from rubber, plastic, composites, metal or any other material utilized and known in the art for manufacturing off-road paddles or cups. The paddle bases 13, 14 may have a generally rectangular footprint or outer perimeter shape as viewed from above in FIGS. 5, 8, 13, 15-19, or an alternative paddle base 19 may have an oval shape as shown in FIG. 11.

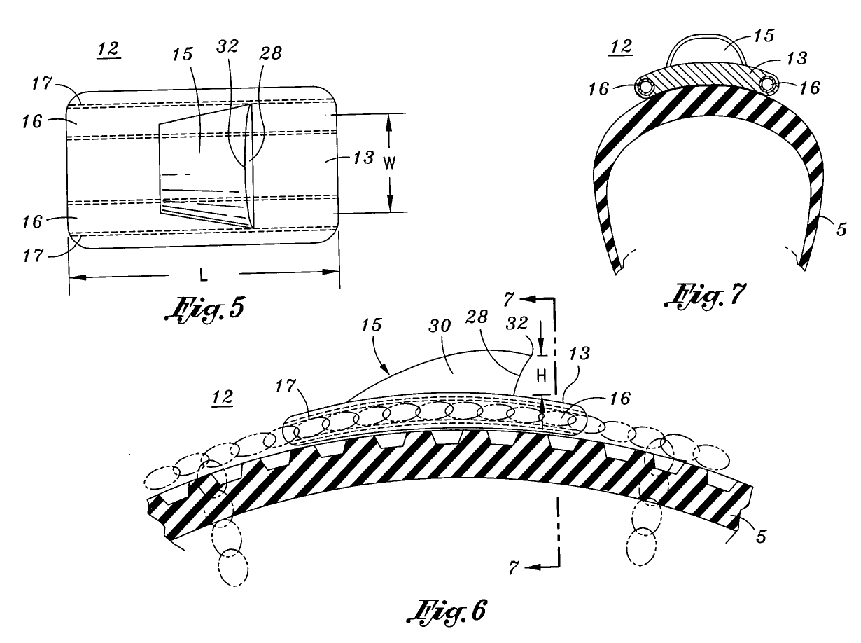

The paddle base 13, 14 may also have a preformed arc shape which conforms to the circular shape of the outer surface or tread of tire 5 (See FIGS. 6, 9, 12A-D, 14A-B, 20 and 21; the circular shape of the tire as viewed from the side) and also to the radial curvature of the tire 5 (See FIGS. 7 and 10; the curvature as viewed from a cross section taken transverse to the rolling direction). In this embodiment, the preformed arc shape of the paddle base 13, 14 may vary according the size and shape of the tire 5.

In the alternative, the paddle base 13, 14 may be formed of a flexible and/or bendable material of which when installed on the outer surface of a tire or tread of tire 5, the material allows the paddle base 13, 14 to bend or conform to the arc shape and rounded sides of the tire 5.

Integrally formed on the top of the paddle base 13, 14, is a paddle or cup 15 which is adapted to scoop the sand, loose dirt, or mud. As depicted in FIGS. 5 through 17 and 20-21, the paddle 15 may have a concave side 28 adapted to engage the loose terrain, and a convex backside 30 which provides backing material behind the concave side 28 for structural strength and to provide an integrally molded interface between the paddle 15 and the base 13, 14. The paddle 15 further has an upper leading edge 32 which may have various forms, such as an arc or straight edge, depending specific paddle 15 design needs. Additionally, the paddle 15 may have a height H (see FIGS. 6 and 9) which is a design parameter that may be adjusted depending on how much digging effect is desired.

Alternative forms of the paddle 15 are shown in FIGS. 18 and 19. One alternative embodiment of the paddle 15 depicted in FIG. 18 has an elongated paddle 15 having a generally triangular cross section that is molded transversely to the base 13, 14 with respect to the direction of rotation of the tire 5. Another alternative embodiment of the paddle 15 depicted in FIG. 19 has an elongated paddle 15 with a generally triangular cross section molded to the base 13, 14 at an angularly inclined position.

It is appreciated that the aforementioned description of the shape of the paddle 15 is merely for exemplary purposes and that the paddle 15 may be formed in a wide variety of shapes that are known in the art of manufacturing or hand carving paddle tires. Therefore, the shape of the paddle 15 is not limited to the exemplary illustrations in FIGS. 5 through 21.

Various Exemplary Embodiments of the Connecting Techniques

Another aspect of the present invention is that there are numerous techniques in which the paddles assemblies 12 may be attached to the chain lattices 23-26. In general, the chain or cable 7 may be attached to the paddle assembly 12 either by (1) arranging the chains longitudinally along the base 13, 14 of the paddle assembly (see FIGS. 5-7, 12A-C, 13, 16, and 18-19); or (2) arranging the chains in a transverse manner across the base 13, 14 of the paddle assembly (see FIGS. 8-11, 12D, 14A-B, and 15-21).

For instance, an exemplary connecting technique used on the first embodiment for attaching the removable tire chain assembly 2 to the chain lattice 24 is shown in FIGS. 1-2 and 5-7. This technique entails forming a pair of retaining conduits 16 within the paddle base 13 such that the chain or cable 7 may be retained inside the retaining conduits 16. In particular, the pair of retaining conduits 16 are arranged in a parallel manner being spaced apart a width W which is the same spacing width between the pair of inner circumferential chains 8 on chain lattice 24. It is further noted that in the instant embodiment, the pair of parallel conduits 16 are arranged in line with the traveling direction of the tire 5. When the removable tire assembly 2 is being assembled, the inner circumferential chains 8 of the lattice 24 are inserted and run through the retaining conduits 16.

Another connecting technique used on the second embodiment is provided for the removable tire chain assembly 3 and lattice 26 as shown in FIGS. 3-4 and 8-10. The technique is similar to that disclosed above in that it entails forming a pair of retaining conduits 16 within the paddle base 14 such that the chain or cable 7 may be retained inside the retaining conduits 16. The difference being that for the removable tire chain assembly 3 and lattice 26, the retaining conduits 16 are oriented transverse to the direction of rotation of the paddle assembly 12. In particular, one of the retaining conduits 16 is disposed in a forward portion of the paddle cup 15 and another retaining conduit 16 is disposed in a rearward portion of the paddle cup 15. Thus, by running the chains or cables 7 through the retaining conduits 16 when the removable tire chain assembly 3 is assembled, the paddle assemblies 12 are retained to the chain lattice 26. Furthermore, to provide added strength to the retaining conduits 16, retaining sleeves 17 may be disposed within the retaining conduits 16, similar to the previous embodiment. The retaining sleeves 17 may be made of any durable material, preferably metal, and may further be shaped to conform to or have the ability to conform to the arc of the paddle base 13 as shown in FIG. 5B.

Another technique that may be utilized to attach the paddle assemblies 12 to the lattices 23-26 is to use fastening hardware. In this case, the retaining conduits 16 and retaining sleeves 17 are not utilized. Instead, the paddle assembly 12 is positioned either directly atop or directly beneath the chain or cable 7 and fastened to the chains 7 by fastening hardware configurations. Any fastener which is capable of being attached to the chain 7 or cable while simultaneously being capable of being attached to or anchored to the paddle assembly 12 is suitable for this application.

For example, FIGS. 12A, 20 and 21 illustrate an exemplary embodiment of the present invention which utilizes J-bolts 46 or U-bolts 52 to attach the chain lattice 23-26 to the paddle assembly 12. In this case, either one receiving hole 42 for a J-bolt 46 or two receiving holes 42 for a U-bolt 58 are provided through the top and bottom of the of the paddle assembly 12. The chain or cable 7 is attached to either the J-bolt or U-bolt 46 and the threaded shafts of the J-bolt or U-bolt 46 are inserted through the receiving holes 42. A backing washer or plate 44 may then be installed on the opposing side of the paddle base 13, 14 and a nut 48 may be installed on the threads to draw the chain or cable 7 tightly against either the top or bottom the paddle base 13, 14.

FIGS. 12B-D depict another embodiment of the present invention in which a plurality of receiving holes 42 are disposed through the top and bottom of the of the paddle assembly 12, and a rivet 50 is utilized to attached the chain 7 to the paddle assembly 12. In this embodiment, the chain lattice 23-26 may either be attached to the bottom or top of the paddle assembly 12. In particular, FIG. 12B shows an embodiment which utilizes transversely oriented chains 18, 20 attached to the top surface of the paddle base 13, 14 by rivets 50. A similar embodiment shown in FIG. 12D further utilizes recesses 54 such that the chains 18, 20 and rivets 50 may be received in the recesses 54. Another embodiment FIG. 12C similar to that of FIG. 12A is provided which utilizes longitudinally oriented chains 8 attached to either the top surface (see FIG. 12C) or bottom surface (not shown; similar to FIG. 12A except rivets 50 are utilized instead of j-bolts or u-bolts 52) of the paddle base 13, 14 by rivets 50.

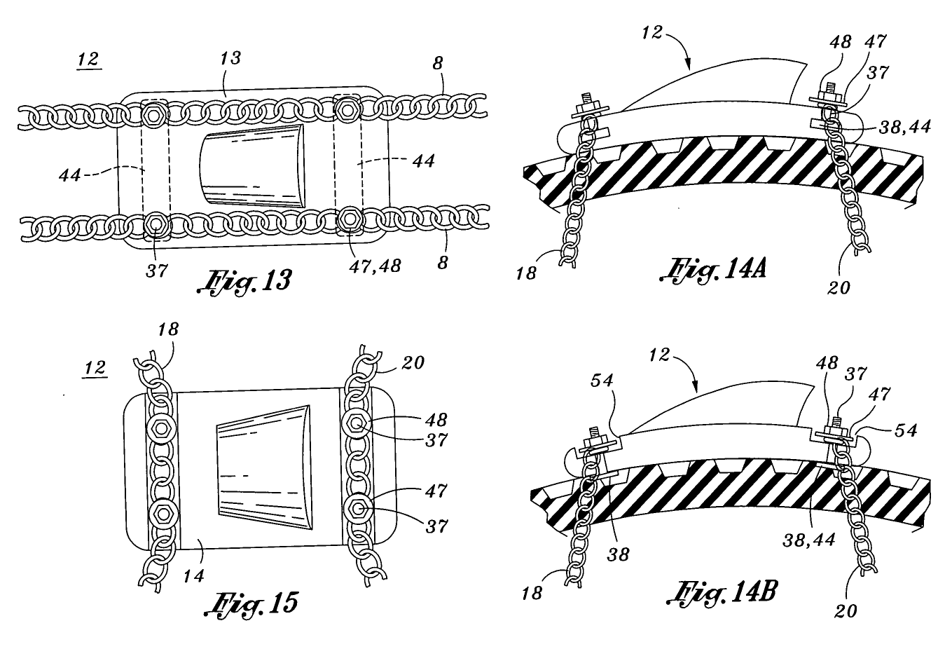

FIGS. 13, 14A-B and FIG. 15 depict other embodiments of the present invention in which a plurality of threaded studs 37 having an anchor protrusion 38 or backing plate 44 are embedded into the paddle base 13, 14. The anchor protrusion 38 or backing plate 44 may be either entirely embedded with the paddle base 13, 14 or the anchor protrusion 38 and the backing plate 44 may be exposed on the bottom side of the base 13, 14.

For example, FIG. 13 shows an embodiment of the paddle assembly 12 which mounts the chains 8 on the topside the paddle base 13 in a longitudinal orientation. A backing plate 44 having threaded studs 37 is fully embedded into the paddle base 13 or partially embedded into the paddle base 13 such that the backing plate 44 is exposed on the bottom side of the paddle base. The chains 8 are then attached to the threaded studs 37 and washers 47 and nuts 48 are secured to the threaded stud 37.

FIGS. 14A-B and FIG. 15 depict an exemplary embodiment of the present invention in which arranges the chains 18, 20 transversely over the top of the paddles base 14 and secure the chains 18, 20 via a plurality of threaded studs 37 having either anchor protrusions 38 or backing plates 44. More specifically, FIG. 14A shows the anchor protrusions 38 or backing plates fully embedded within the paddle base 14. In the alternative, FIG. 14B shows the anchor protrusions 38 or backing plates 44 being partially exposed on the bottom side of the paddle base 14.

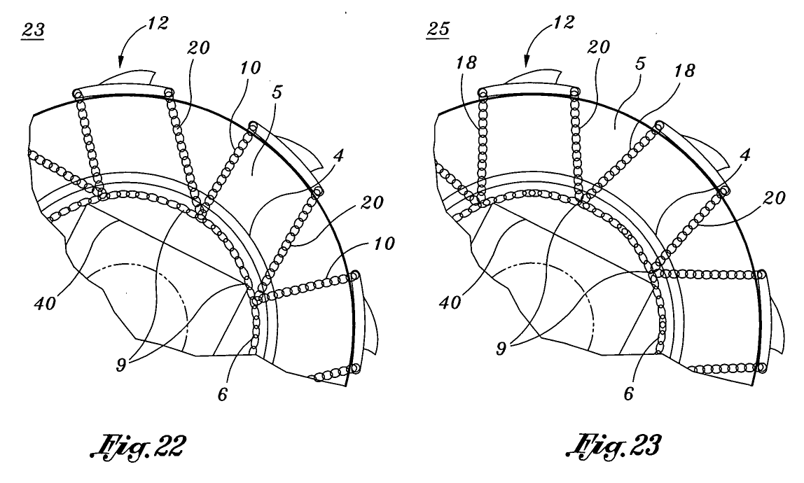

Moreover, FIGS. 14B and 15 show a recessed feature 54 which allows the chains 18, 20 to be received within the recess 54 to provide a lower obstruction profile with regard to the placement of the chains 18, 20 over the top of the paddle base 14. It is acknowledge that recesses may be implemented in a variety of manners with respect to the present invention, and therefore, should the use of the recesses 54 should not be limited to the embodiments illustrated. For instance, recesses 54 are also utilized in FIGS. 20 and 21, which are described in greater detail later in the specification. The recesses 54 may take the form of a groove which is transversely disposed across the entire paddle base as shown in FIG. 15, or in recesses 54 which are shaped only to receive portions of the mounting hardware, such as is depicted in FIGS. 20 and 21.

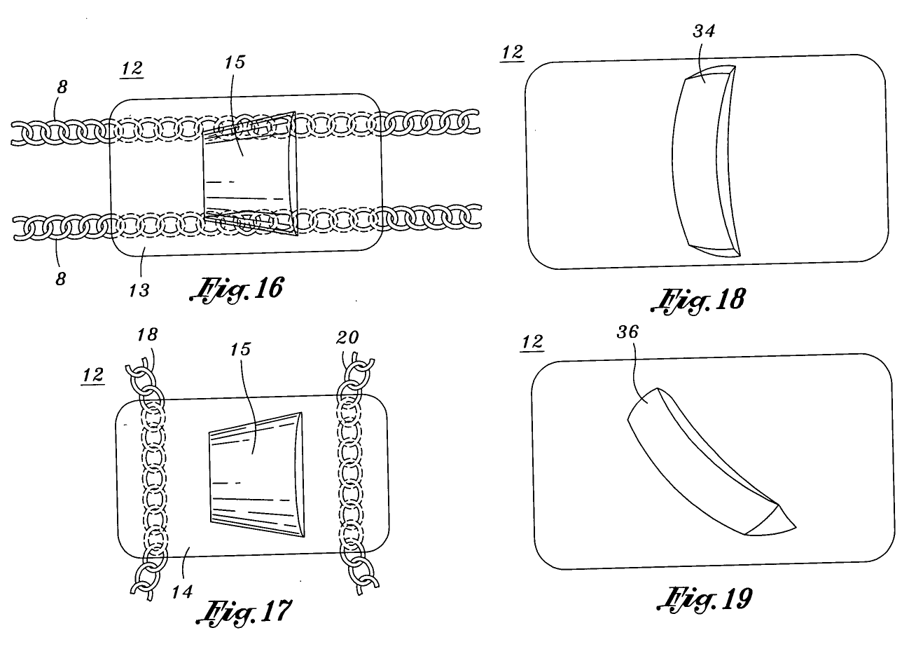

FIGS. 16 and 17 illustrate other exemplary embodiments of the present invention in which the chain or cable 7 is directly embedded into the paddle base 13, 14. In FIG. 16, the pair of inner circumferential chains 8 from the chain lattice 24 are oriented in a longitudinal manner in the paddle base 13. In FIG. 17, the declined or inclined radially oriented chains 18, 20 from chain lattices 23, 25 and 26 are oriented transversely within the paddle base 14.

FIGS. 20 and 21 are side views of another embodiment of the paddle assembly 12 which utilizes recesses/and or U-bolts 52 for the mounting hardware, according to an aspect of the present invention. As shown in FIG. 20, recesses 54 may be formed in the top surface to receive the mounting hardware 48, 44. Or as shown in FIG. 21, recesses 54 may be formed in the bottom surface of the paddle base 14 to receive the mounting hardware. Both FIGS. 20 and 21 illustrate the use of a U-bolt 52, backing plate 44, and nuts 48 and washers 47 and washers 48 to secure the lattice 23, 25, 26 to the paddle assembly 12.

Functionality and Operation of the Present Invention

One aspect of the removable chain assembly 2, 3 is that it may be temporarily installed over a conventional tire of a vehicle, such as a motorcycle, ATV, or off-road vehicle and the like. In most cases, the tire chain assemblies 2, 3 are only installed on the wheels 4 which are directly driven by the drivetrain. For instance, a motorcycle would use a tire chain assembly 2, 3 on the rear tire 5 since the rear wheel 4 is driven by the engine, as compared to the free spinning front wheel. Or depending on whether a vehicle, such as an ATV, sandrail, dune buggy or truck, was two-wheel or four-wheel drive, the vehicle would either use a pair of chain assemblies 2, 3 in the rear for two-wheel drive, and could use four chain assemblies 2, 3 for a four-wheel drive configured vehicle.

The removable tire chain assemblies 2, 3 are installed similarly to that of any other tire chain set. Before installation, an assessment of the tire 5 and wheel clearance with respect to the rest of the vehicle should be performed. For instance, sufficient clearance between a motorcycle swingarm and the top surface of the conventional tire 5 should be present such that the paddles 15 do not rub or interfere with the swingarm. Or similarly with a vehicle, sufficient space is required between the fenders and the top surface of the conventional tire 5 so that the paddles 15 do not rub or interfere with the fenders.

When installing the tire chain assemblies 2, 3, the lattice 23-26 is wrapped around the tire 5 such that the concave surfaces 28 on the paddles 15 will dig into the ground. In other words, the tire chain assemblies 2, 3 should be properly installed according to the direction of the tire rotation. The lattice 23-26 is arranged such that it has two opposing connecting ends. In particular, as already discussed lattice 24 has a plurality of chain releases or connectors 11 connected to the terminated ends of the pair of outer and inner circumferential chains 6, 8 as illustrated in FIGS. 1 and 2. With respect to lattice 26, a plurality of chain releases or connectors 11 are connected to the terminated ends of the pair of the outer circumferential chains 6 and spliced in portions of one of the inclined rearward chains 18 as illustrated in FIGS. 3 and 4. When the lattice 23-26 is wrapped around the tire 5 and rim 4, the chain releases 11 are connected so that the tire chain assembly 2, 3 will be installed over the tire tread and around the radial curvature or sidewalls of the tire 5.

The tire chain assemblies 2, 3 further include a tensioner 40 on each side of the assembly 2, 3 for drawing down or tightening the pair outer circumferential chains 6. In particular, the tensioner 40 may comprise a resilient cord or another chain which is connected to various portions or chain joints on each of the outer circumferential chains 6.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such are within the scope of the appended claims.

1. A removable tire chain assembly with paddles for motorcycles, ATVs, and off-road recreational vehicles, for enhancing traction in sand, loose dirt and muddy terrain, said tire chain assembly comprising:
a chain lattice, having opposing connecting ends, adapted to be circumferentially and radially wrapped around and secured about a tire and rim; and
a plurality of paddle assemblies attached to said chain lattice such that said plurality of paddle assemblies are positioned on a tread portion of the tire.

2. The tire chain assembly according to claim 1, said chain lattice comprising,
a pair of inner circumferential chains arranged in parallel relation to each other;
a plurality of radially oriented chains transversely intersecting and interconnected to said pair of inner circumferential chains; and
a pair of outer circumferential chains comprising,
a leftside chain laterally positioned away from and generally parallel to said pair of inner circumferential chains;
a rightside chain laterally positioned away from and generally parallel to said pair of inner circumferential chains;
wherein said plurality of radially oriented chains are transversely interconnected to and terminated at said pair of outer circumferential chains.

3. The tire chain assembly according to claim 1, said chain lattice comprising,
a pair of outer circumferential chains comprising a leftside chain laterally positioned away from and generally parallel to a rightside chain;
a plurality of forward radially oriented chains interconnecting said pair of outer circumferential chains, said plurality of forward radially oriented chains attached to said pair of outer circumferential chains in a declined orientation, each of said forward radial oriented chains having a leftside and rightside connecting portion; and
a plurality of rearward radially oriented chains generally transversely positioned between said pair of outer circumferential chains, each rearward radially oriented chain having a left end attached to a leftside connecting portion and a right end attached to a rightside connecting portion of a respective one of said plurality of forward radially oriented chains.

4. The tire chain assembly according to claim 1, each of said plurality of paddle assemblies comprising,
a paddle base; and
a paddle integrally formed to said paddle base.

5. The tire chain assembly according to claim 4, said paddle base comprising a generally planar member having one of a rectangular and oval footprint.

6. The tire chain assembly according to claim 4, said paddle base having a preformed arc which conforms to the tire.

7. The tire chain assembly according to claim 4, said paddle base formed of a pliable material which when installed on the outer surface of the tire, said paddle base bends and conforms to a circular arc and rounded sides of the tire.

8. The tire chain assembly according to claim 4, said paddle having a concave side adapted to engage terrain and a backing portion formed behind the concave side

9. The tire chain assembly according to claim 8, said concave side of said paddle oriented transverse to a rotational direction of the tire.

10. The tire chain assembly according to claim 8, said concave side of said paddle oriented at an inclined angle with respect to a rotational direction of the tire.

11. The tire chain assembly according to claim 8, said paddle having a generally triangular cross section defined by said concave side and said backing portion.

12. The tire chain assembly according to claim 4, said paddle base having a pair of receiving conduits formed internally for receiving portions of said chain lattice.

13. The tire chain assembly according to claim 12, said paddle base further comprising retaining sleeves disposed within the receiving conduits for receiving portions of said chain lattice.

14. The tire chain assembly according to claim 12, wherein the receiving conduits are oriented transverse to a rotational direction of the tire.

15. The tire chain assembly according to claim 12, wherein the receiving conduits are oriented parallel to a rotational direction of the tire.

16. The tire chain assembly according to claim 4, said paddle base being attached to portions of said chain lattice by fastening hardware.

17. The tire chain assembly according to claim 16, said fastening hardware comprising at least one of J-bolts and U-bolts.

18. The tire chain assembly according to claim 16, said fastening hardware comprising rivets.

19. The tire chain assembly according to claim 17, said fastening hardware further comprising at least one of a backing plate, washer and fastening nut.

20. The tire chain assembly according to claim 16, said fastening hardware comprising a threaded stud with an anchor protruding from said stud, wherein a portion of said stud is embedded within said paddle base and a threaded portion is exposed for receiving fastening hardware.

21. The tire chain assembly according to claim 4, wherein said paddle base is molded with portions of said chain lattice positioned within and embedded within said paddle base for attaching said paddle base to said chain lattice.

22. The tire chain assembly according to claim 1, said chain lattice comprising,
a pair of outer circumferential chains comprising a leftside chain laterally positioned away from and generally parallel to a rightside chain;
a plurality of declined forward radially oriented chains interconnecting said pair of outer circumferential chains, said plurality of forward radially oriented chains attached to said pair of outer circumferential chains in a declined orientation; and
a plurality of inclined rearward radially oriented chains interconnecting said pair of outer circumferential chains, said plurality of rearward radially oriented chains attached to said pair of outer circumferential chains in a inclined orientation;
wherein said declined forward radially oriented chains and inclined rearward radially oriented chains are connected to said pair of outer circumferential chains at a common chain joint.

23. The tire chain assembly according to claim 1, said chain lattice comprising,
a pair of outer circumferential chains comprising a leftside chain laterally positioned away from and generally parallel to a rightside chain;
a plurality of declined forward radially oriented chains interconnecting said pair of outer circumferential chains, said plurality of forward radially oriented chains attached to said pair of outer circumferential chains in a declined orientation; and
a plurality of rearward radially oriented chains interconnecting said pair of outer circumferential chains;
wherein said declined forward radially oriented chains and rearward radially oriented chains are connected to said pair of outer circumferential chains at a common chain joint.

24. The tire chain assembly according to claim 4, said paddle base having at least one recess disposed on at least one of an upper surface and lower of said paddle base to receive fastening hardware.

25. The tire chain assembly according to claim 4, said paddle base having at least one hole disposed through an upper surface and lower surface of said paddle base to receive fastening hardware.

26. The tire chain assembly according to claim 20, said anchor being a backing plate interconnecting a pair of threaded studs, wherein said backing plate is transversely positioned across said paddle base.

27. The tire chain assembly according to claim 26, wherein said backing plate is embedded within said paddle base.

28. The tire chain assembly according to claim 26, wherein said backing plate is exposed on a bottom side of said paddle base.

29. The tire chain assembly according to claim 24, wherein the at least one recess is transversely positioned across one a top side or bottom side of said paddle base.
